(19) United States
(12) Patent Application Publication
(10) Pub. No.: US 2009/0121831 A1
(43) Pub. Date: May 14, 2009

(54) DYNAMIC REPROGRAMMING OF AN INTELLIGENT CONTROLLER UTILLIZING A SMART CARD

(75) Inventor: Jeffrey S. Zingsheim, Franklin, WI (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/937,987

(22) Filed: Nov. 9, 2007

(51) Int. Cl. G05B 19/00

(52) U.S. Cl. 340/5.22

(57) ABSTRACT

A system for updating remote control devices includes a portable programmable medium having a data storage device for storing data. The control devices include a processor or a computer having a data storage device for storing data. The system further includes a network for transferring data between a local reader and one or more remote control devices communicating via the network.

### FIELD OF THE INVENTION

The present invention relates to a system for updating a control device, and more specifically, a system for updating a control device having a computer using a portable programmable medium including data.

### BACKGROUND OF THE INVENTION

Currently, control devices such as access control panels for a security access device or a door locking device are reprogrammed by an operator utilizing a desktop or laptop computer connected either directly to an access control panel or connected via a computer network. The reprogramming may include changing or adding access information pertaining to access credentials. Utilizing the physical or network connection, the operator can reprogram the access control panel's configuration information or even the control panel's firmware. A disadvantage of this approach is that a technician and a computer are required. Other disadvantages include the time required for a technician to complete the upgrade or installation, and requiring operator proficiency with the requisite software for interfacing with the control panel.

Therefore, a need exists for a system or method to increase the efficiency and frequency of updates to a control device or a control panel, e.g., an access control panel, managing, for example, a security system.

### SUMMARY OF THE INVENTION

In an aspect of the invention, a system for updating a control device includes at least one remote control device including a processor and a memory device for storing data. A network provides access to the remote control device, and a portable programmable medium includes data. A local reader communicates with the remote control device via the network, and the local reader reads the data on the portable programmable medium and transfers at least part of the data to the remote control device. The system may also include the network providing communication to a plurality of remote control devices each including a processor. Additionally, the system may include the local reader connected to at least one local control device, and the local control device communicates with the remote control device via the network.

In a related aspect, the local reader communicates with a plurality of remote control devices via the network and the remote control devices are remotely located with respect to the local reader. In another embodiment, at least one remote control device manages entry and exit of a secure area, which may be a building. Alternatively, at least one remote control device may manage temperature in a building. Further, at least one remote control device may manage lighting in a building, or a building automation system.

In another aspect of the invention, a system for updating a control device of a security system includes a network for transferring data, and at least one remote control device for managing access of a secured area, where the remote control device includes a processor and a memory device for storing data. A portable programmable medium includes specified data, and a local reader is for authenticating and communicating the specified data of the portable programmable medium. The local reader is located locally with respect to the remote control device and communicates via the network. The local reader reads the specified data in the portable programmable medium and transfers the specified data via the network to the memory device of the remote control device. The system may also includes a plurality of remote control devices. Further, the system may include a plurality of remote control devices communicating with the local reader via the network, where at least one local control device is located locally with respect to the local reader and communicating with the local reader.

In another aspect of the invention, a method for updating a control device includes: providing a remote control device remotely located with respect to a local reader, and the remote control device including a processor and a memory device for storing data; providing communication between the remote control device and the local reader via a network; programming a portable programmable medium; storing data on the portable programmable medium; reading the portable programmable medium data using the local reader; and communicating the data to the remote control device via the network.

In a related aspect, the method includes: transferring the data between the local reader and a local control device; and transferring the data between the local control device and a plurality of remote control devices communicating via the network.

### BRIEF DESCRIPTION OF THE DRAWINGS

These and other objects, features and advantages of the present invention will become apparent from the following detailed description of illustrative embodiments thereof, which is to be read in connection with the accompanying drawings, in which:

FIG. 1 is a block diagram depicting a system for updating local and remote control panels according to an embodiment of the invention including a smart card, and a local reader connected via a network; and

FIG. 2 is a block diagram depicting another embodiment of the invention having the local reader directly connected to the network and thereby the remote control panels.

### DETAILED DESCRIPTION OF THE INVENTION

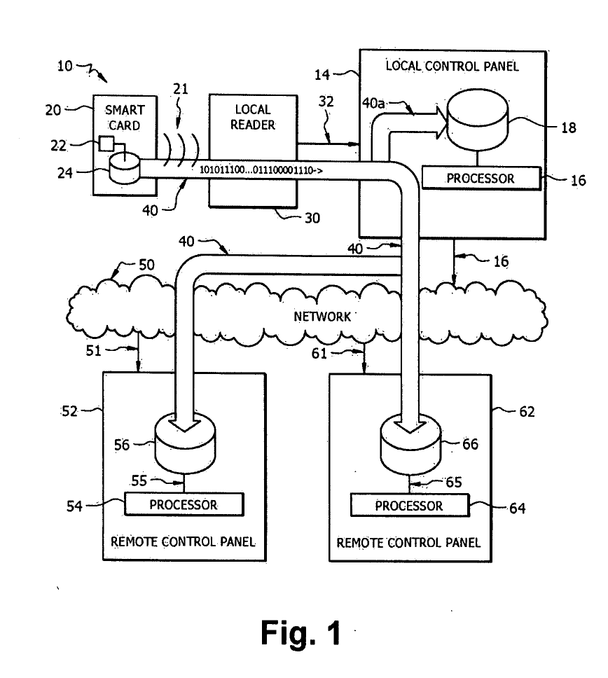

An illustrative embodiment of a system 10 for updating control devices embodied as local control panel 14 and remote control panels 52, 62 according to the present invention is shown in FIG. 1 and includes a portable programmable medium embodied as a smart card 20. The smart card 20 includes a processor 22 and a data storage device 24. The local control panel 14 includes a processor 16 and a data memory device 18 for storing data. A local reader 30 communicates with the local control panel 14 using a connection 32 to transfer data 40 from the local reader 30 and smart card 20 to the local control panel 14. The connection 32 may be, for example, a local area network using Ethernet technology.

The smart card 20 may also include a card identification (ID) managed by the processor 22 and used for authentication of the smart card 20, and thereby, the user presenting the smart card 20. The data in the smart card 20 may include data particular to a software application such as access rules for security purposes, or upgrading control panel firmware. Alternatively, the portable programmable medium may be embodied for example, as a card having a magnetic strip, or a universal serial bus (USB) memory device, or a cell phone.

The system 10 further includes a network 50 communicating with a plurality of remote control panels 52, 62 and the local reader 30. In alternative embodiments, for example, the network may connect to only one remote control device or many remote control devices. The local reader 30 communicates with processors 54, 64 of the remote control panels 52, 62, respectively via network connection 16 connecting the local control device 14 to the network 50. The network connection 16 may be, for example, wired or wireless communication. Similarly, network connection 51, 61 to the remote control panels 52, 62, respectively, may be wired or wireless. Further, the network 50 may include, for example, the Internet, or other wired or wireless networks.

The remote control panels 52, 62 include data storage devices 56, 66 connected by communications links 55, 65 to processors 54, 64, respectively, for receiving and sorting the data 40. In an alternative embodiment, the data may not be stored in data storage device 18 or processed using processor 16 in the local control panel 14, but transferred from the local reader 30 to the remote control panels 52, 62 using the connection provided by the local control panel 14 and the network 50.

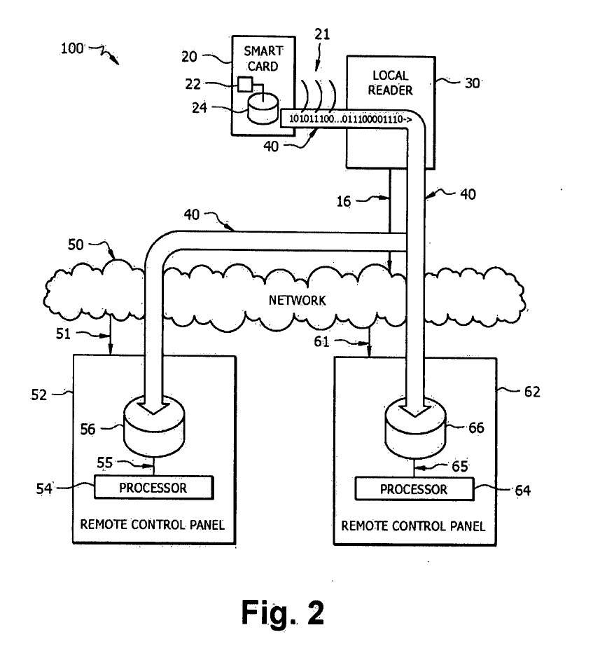

Referring to FIG. 2 where like elements have the same reference numerals as in FIG. 1, another embodiment of a system for updating control devices 100 according to the present invention includes the smart card 20 transmitting data 40 to the local reader 30. However, in the system 100 the local reader is connected 16 to the network 50 for transferring data 40 to the remote control devices embodied as remote control panels 52, 62 directly without the use of the local control panel 14, as shown in FIG. 1. As in the system 10 shown in FIG. 1, the local reader 30 may connect via the network 50 to one or more remote control panels 52, 62. Thus, the card 20 and local reader 30 do not have to be located proximate the remote control panels 52, 62, as shown in FIG. 2. The network 50 could be, for example, a corporate wide area network (WAN), the Internet, or a local area network (LAN). Thus, the user doesn't have to be at the same physical location as the remote control panels 52, 62 to upgrade data or software, for example, the control devices firmware. The ability to remotely upgrade data or software is especially advantageous for systems or business with multiple locations, such as a global manufacturing and banking where administrators are generally located at a central location and control devices are widespread within their corporate network. A further advantage of the present invention includes the advantage of a single smart card 20 read using the local reader 30 upgrading multiple remote control panels 52, 62 simultaneously via the network 50.

Referring to FIG. 1, the system 10 may be used with local and/or remote control devices embodied as local control panel 14 and remote control panels 52, 62 for managing security systems such as entry and exit of a secured area, for example, the remote control panels 52, 62 may control security at doors for entry into a secure room or building, or control security of a fenced area, parking lot, a ship or other embodiments of secured areas. Additionally, the local reader 14 and remote control panels 52, 62 may be used to control or manage a building automation system, which includes, for example, temperature control, or lighting control where temperature and lighting can be adjusted or switched on and off based on need and/or compliant with a time schedule. Further, the local and remote control panels 14, 52 and 62, respectively, may manage access to a secure elevator, a gate for controlling a secure area, or control of a time-clock. Additionally, the control panels may manage devices with integrated logical access control functions, e.g., allowing/denying login to a computer, or network, or network appliances, for example, a router, or firewall.

In operation, referring to FIG. 1, the smart card 20 transfers data 40 to the local reader 30. The local reader 30 is connected 32 to the local control panel 14 and transfers the data 40 to the data storage device 18. The local control panel 14 is connected 16 to the network 50. The connection 16 may be, for example, wired or wireless. The local control panel 14 transfers the data 40 to remote control panels 52, 62 via the network 50.

Further, in an alternative embodiment, the smart card 20 may include data storage capacity for a programmer (e.g., at the manufacturer, distributor, system integrator, or remote end-users' facility) to program one or more smart cards with necessary programming, configuration, and/or firmware files for upgrading an access control device or panel. When the card is scanned by a compatible smart card reader connected either directly or via a network to a compatible access control panel, the programming information, configuration information, and/or firmware files stored on the card are automatically transferred to the access control device or panel and used to reprogram, reconfigure, or update the device's firmware. Additionally, the smart card could be programmed to limit its use to a single use, or use on a specific or limited set of access devices.

While the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. A system for updating a control device, comprising:
at least one remote control device including a processor and a memory device for storing data;
a network providing access to the remote control device;
a portable programmable medium including data; and
a local reader communicating with the remote control device via the network, and the local reader reading the data on the portable programmable medium and transferring at least part of the data to the remote control device.

2. The system of claim 1, wherein the network provides communication to a plurality of remote control devices each including a processor.

3. The system of claim 2, wherein the local reader is connected to at least one local control device.

4. The system of claim 3, wherein the local control device communicates with the remote control device via the network.

5. The system of claim 1, wherein the local reader communicates with a plurality of remote control devices via the network and the remote control devices are remotely located with respect to the local reader.

6. The system of claim 5, wherein at least one remote control device manages entry and exit of a secure area.

7. The system of claim 6, wherein the secure area is a building.

8. The system of claim 5, wherein at least one remote control device manages temperature in a building.

9. The system of claim 5, wherein at least one remote control device manages lighting in a building.

10. The system of claim 5, wherein at least one remote control device manages a building automation system.

11. A system for updating a control device of a security system, comprising:
a network for transferring data;
at least one remote control device for managing access of a secured area, and the remote control device including a processor and a memory device for storing data;
a portable programmable medium including specified data; and
a local reader for authenticating and communicating the specified data of the portable programmable medium, and the local reader being located locally with respect to the remote control device and communicating via the network, and the local reader reading the specified data in the portable programmable medium and transferring the specified data via the network to the memory device of the remote control device.

12. The system of claim 11, further including a plurality of remote control devices.

13. The system of claim 11, further including a plurality of remote control devices communicating with the local reader via the network, and at least one local control device being located locally with respect to the local reader and communicating with the local reader.

14. A method for updating a control device, comprising:
providing a remote control device remotely located with respect to a local reader, and the remote control device including a processor and a memory device for storing data;
providing communication between the remote control device and the local reader via a network;
programming a portable programmable medium;
storing data on the portable programmable medium;
reading the portable programmable medium data using the local reader; and
communicating the data to the remote control device via the network.

15. The method of claim 14, further including:
transferring the data between the local reader and a local control device; and
transferring the data between the local control device and a plurality of remote control devices communicating via the network.
